(19) United States
(12) Patent Application Publication
(10) Pub. No.: US 2009/0048982 A1
(43) Pub. Date: Feb. 19, 2009

(54) Method of computing a settlement price

(76) Inventors: Dean Payton, Glen Ellyn, IL (US); Brian M. Wolf, Roselle, IL (US)

Correspondence Address: MCCRACKEN & FRANK LLP, 311 S. WACKER DRIVE, SUITE 2500, CHICAGO, IL, 60606, US

(21) Appl. No.: 11/891,746

(22) Filed: Aug. 13, 2007

(51) Int. Cl. G06Q 40/00

(52) U.S. Cl. 705/36 R; 705/37

(57) ABSTRACT

A computer assisted method of operating a venue of an exchange comprises the steps of providing a market for trading of a product, acquiring a measure of trading volume of the product, and developing a measure of open interest in the product. A relationship is calculated between the measure of trading volume and the measure of open interest. A settlement price is computed in accordance with the relationship, and the settlement price is published.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to a method of operating a market, and particularly to a method of computing a settlement price for a product traded in a market.

2. Description of the Background of the Invention

An exchange provides one or more venues for the purchase and sale of various types of products including financial instruments such as stocks, bonds, futures contracts, options, cash, and other similar instruments. A futures contract is a contract to purchase or sell a commodity or financial instrument for delivery in the future at a price that is determined at the initiation of the contract. A transaction is the purchase or sale of any of the above financial instruments and similar instruments, as well as similar rights and obligations.

Generally, each exchange establishes specifications for each product traded on a market. The specifications define at least the product traded in the market, minimum quantities that must be traded, and a minimum price increment in which the product can be traded. For some types of products, for example, futures, the specification further defines a quantity of the underlying goods or financial instruments represented by one unit (or lot) of the product, an expiration date of the product, and a delivery date for the underlying goods or financial instruments.

A minimum price fluctuation for a product is defined as a tick. Therefore, prices for a product are constrained to values that differ only by multiples of the tick. A bid price is a price offered by a trader seeking to buy a quantity of the product and an offer price is a price sought by a trader seeking to sell a quantity of the product. An order comprises a bid or offer price and a quantity to be bought or sold, respectively. Therefore, a bid is an order to buy and an offer is an order to sell. For example, a bid for a futures contract may be for a quantity of 200 contracts at 95 dollars each.

Typically, only traders authorized by an exchange are allowed to trade directly on the exchange; however, brokerages or persons who are not affiliated with the exchange may also place orders through authorized traders. All accounts trading the exchange's products must be carried by an authorized clearing firm and guaranteed by the clearing firm to a central clearing house associated with the exchange. All accounts carried by the authorized clearing firms are marked to market and subject to minimum performance bond requirements established by the exchange. The performance bonds represent good faith deposits to guarantee performance and represent a minimum amount of protection against potential losses that each clearing firm must maintain to carry a position or portfolio of positions. Should the performance bond on deposit fall below a designated level, the account must be re-margined to the initial performance bond level. To determine if re-margining is required, all open positions held in a product are marked to market during or at the end of each trading session by determining a settlement price and marking open positions to the settlement price. A net change in the value of a trader's account is computed based upon the settlement price and a value of all the open positions held in a trader's account is updated to reflect the net change. Re-margining cash flows between the clearing firms and the clearing house remove any debt obligations therebetween and safeguard the financial integrity of the market by not allowing losses to accumulate over time. Periodic settlement of accounts assures that all parties involved in trading through an exchange are solvent and can meet their obligations to one another and to the exchange.

Some products on an exchange are traded in an open outcry venue where the exchange provides a location for buyers and sellers to meet and negotiate a price for a quantity of a product. Other products are traded on an electronic venue, for example, an electronic trading platform, where a trader uses software to send an order to the electronic trading platform. The order identifies the product, the quantity of the product the trader wishes to trade, a price at which the trader wishes to trade the product, and whether the order is a bid or an offer.

Markets for some products operate simultaneously in both open outcry and electronic venues. In this situation, price variations that may develop between the venues are quickly eliminated by traders who arbitrage between the venues. Therefore, in a situation where a single product is traded on two venues, prices on the two venues tend to closely track each other. The operating hours of the venues may be different and one of the two venues may stop trading at a predetermined time while the other venue continues trading, possibly without ever stopping. Settlement prices for a product traded in a market that operates on more than a single venue must still be periodically established for the reasons described above. Settlement prices for a product may be established using a number of methods.

One way an open outcry venue establishes the settlement price for a product is by a decision made by a settlement committee. The settlement committee typically consists of several traders who review and discuss trading data to determine the settlement price considered to represent fair value at a discrete moment in time. Another way to establish the settlement price for a product is to set the settlement price to be identical to a price of a last trade executed before a predetermined settlement time. If two markets are provided for the same product, the settlement price of the product on one of the two markets may be based on the settlement price of the product on the other of the two markets. For example, the settlement price for a product trading on a first exchange (or venue thereof) may be set identical to a price of a last trade executed on a coincidentally operating second exchange (or venue thereof) or on a coincidentally operating second venue of the first exchange before a predetermined settlement time.

A further way to establish the settlement price for a product is to compute a volume weighted average price (“VWAP”) for the product. The VWAP may be computed, for example, by the relation:

$$VWAP = ( \frac{{\sum }_{k} ( {Quantity}_{k} ) \cdot ( {Price}_{k} )}{{\sum }_{k} ( {Quantity}_{k} )} )$$

where the summation index k represents the number of trades that occur during a predetermined time period, Quantityₖ represents quantity of product traded in each of the summed trades, and Priceₖ represents a corresponding price for the product traded in each of the summed trades.

In some markets, the settlement price is set equal to the computed VWAP. Still another way to establish the settlement price for a product is to set the settlement price for the product trading on a first exchange (or venue thereof) equal to the VWAP for the product computed from trading data acquired from a second exchange (or venue thereof) that operates coincidentally with the first exchange or from a coincidentally operating second venue of the first exchange.

Yet other ways adjust the computation of the settlement price to be responsive to trading conditions for a product. Such ways compare parameters that are computed from trading data to determine the exact procedure for determining the settlement price. An example of one such parameter is a quotient of open interest of a product having a particular contract expiration month (“contract month”) divided by open interest of the product including all of the contract months. Illustratively, suppose the product in question is a hypothetical soybeans futures contract that has contract months of March, May, July, August, September, November, and January. Open interest in a soybeans futures contract is the number of contracts that have been traded and that have not yet closed or been delivered. An open interest parameter for the soybeans futures contract in this illustration may be the quotient of open interest of the July expiration futures contract divided by a sum of the open interest of the futures contract over all of the contract months. An example of another such parameter is a quotient of volume traded during a predetermined time period of a product having a particular contract month divided by volume traded during the predetermined time period of the product including all of the contract months. Illustratively using the same hypothetical soybeans futures contract discussed above, an open interest parameter for the soybeans futures contract in this illustration may be the quotient of volume traded during a predetermined time period of the July expiration futures contract divided by a sum of the volume traded during a predetermined time period of the futures contract over all of the contract months.

### SUMMARY OF THE INVENTION

According to one aspect of the invention, a computer assisted method of operating a venue of an exchange comprises the steps of providing a market for trading of a product, acquiring a measure of trading volume of the product, and developing a measure of open interest in the product. A relationship is calculated between the measure of trading volume and the measure of open interest. A settlement price is computed in accordance with the relationship, and the settlement price is published.

According to another aspect of the invention, a method of using a computer to determine a settlement price for a product traded on a venue of an exchange comprises the steps of acquiring a measure of trading volume of the product and developing a measure of open interest in the product. A relationship is calculated between the measure of trading volume and the measure of open interest. A settlement price is computed in accordance with the relationship.

According to yet another aspect of the invention, a method of using a computer to determine a settlement price for a product traded on a first venue comprises the steps of acquiring a measure of trading volume of the product from a second venue, developing a measure of open interest in the product, and collecting bid and offer prices for the product. A relationship is calculated between the measure of trading volume and the measure of open interest. A settlement price is computed in accordance with the relationship and the bid and offer prices.

According to a further aspect of the invention, a system for operating a venue that provides a market for trading a product comprises a computer-readable medium and a software program stored in the computer-readable medium. The software program comprises a first routine that acquires a measure of trading volume of the product, a second routine that develops a measure of open interest in the product, and a third routine that calculates a relationship between the measure of trading volume and the measure of open interest. The software program further comprises a fourth routine that computes a settlement price in accordance with the relationship and a fifth routine that publishes the settlement price.

According to a still further aspect of the invention, a method of using a computer to periodically update a trader's account comprises the steps of determining a marked to market price a plurality of times during a trading session for a product traded on an exchange and calculating a net change of the trader's account based upon the determined marked to market price. The method also updates the trader's account based upon the calculated gains and losses.

### BRIEF DESCRIPTION OF THE DRAWINGS

FIG. 1A is a schematic representation of an embodiment of a market that has multiple venues operating on a single exchange for trading a product;

FIG. 1B is a schematic representation of another embodiment of a market that is traded on multiple venues, each venue operating on a distinct exchange for trading a product;

FIG. 2 is a timeline diagram illustrating typical daily exchange activity;

FIG. 3 is a block diagram illustrating market operation;

FIG. 4 is a block diagram illustrating settlement procedures;

FIG. 5 is an illustration of related futures contract families;

FIG. 6 is a block diagram illustrating computation of a settlement price;

FIG. 7 is a chart showing example settlement prices and open interests; and

FIG. 8 is an overview description of the settlement data shown in FIG. 7.

Other aspects and advantages of the present invention will become apparent upon consideration of the following detailed description, wherein similar structures have similar reference numerals.

### DETAILED DESCRIPTION

While specific embodiments of a method of computing a settlement price are discussed herein, it is understood that the present disclosure is to be considered only as an exemplification of the principles of the invention. The present disclosure is not intended to limit the disclosure to the embodiments illustrated.

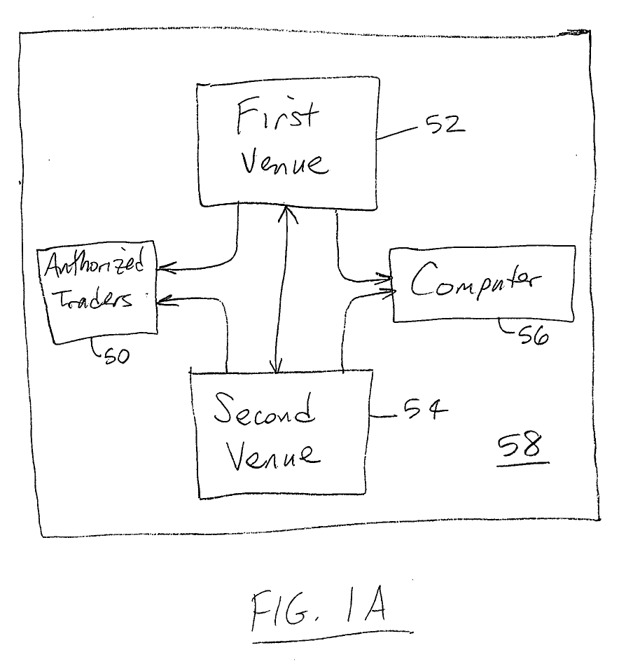

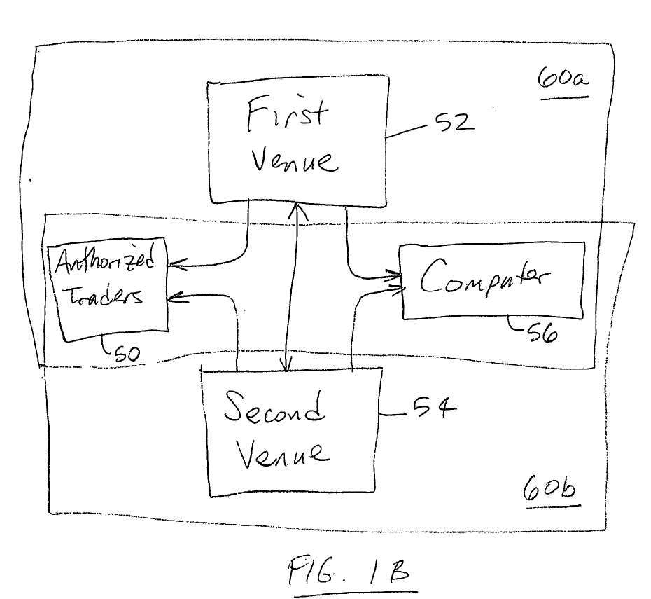

Referring to FIGS. 1A and 1B, authorized traders 50 trade a product in a market that may comprise a first venue 52 and a second venue 54. Trading data is passed between the traders 50, and the exchanges 52, 54. Trading data may include, for example, bid and offer quantities and prices, matched bids and offers, or other data. An associated computer 56 computes a settlement price as required for products traded in certain markets. In one embodiment shown in FIG. 1A, each of the first and second venues 52, 54 may operate as part of a single exchange 58. In another embodiment shown in FIG. 1B, the first venue 52 may operate as part of a first exchange 60a and the second venue 54 may operate as part of a second exchange 60b.

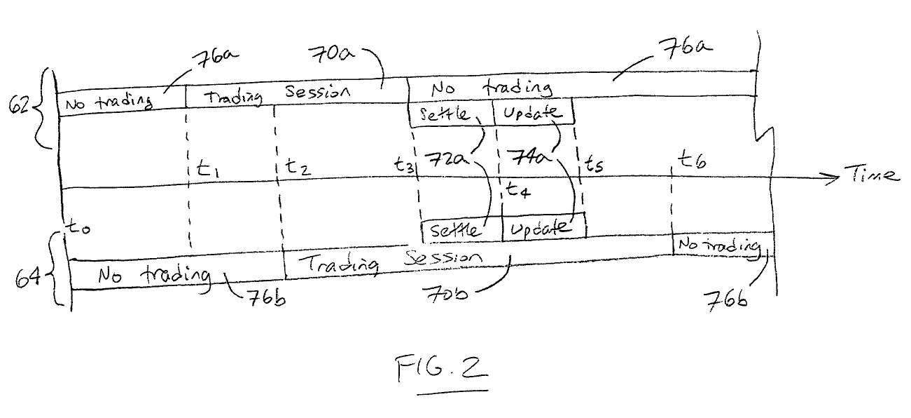

FIG. 2 shows first and second timelines 62 and 64 that illustrate trading sessions of a market comprising the first and second venues 52 and 54, respectively. Trading activity in a typical market begins when the market opens. A product is traded in the market as illustrated in FIG. 1, for example, on the first venue 52 and on the second venue 54. During a normal trading day as indicated in FIG. 2, there may be no trading activity on either of the first or second venues 52, 54 from a time to a time t₁. The first venue 52 may open at the time t₁ and the second venue 54 may open at a different time t₂. A trading session 70a continues on the first venue 52 until a predetermined settlement time t₃ when the trading session on the first venue closes. A trading session 70b opens at the time t₂ on the second venue 54. In this example, the trading session 70a on the first venue 52 closes at the predetermined settlement time t₃, but the trading session 70b on the second venue 54 continues beyond the time t₃ and closes at a time t₆.

A block 72a determines a settlement price for the product at the predetermined settlement time t₃. A Block 74a applies the settlement price determined by the block 72a to traders' positions to update traders' accounts at a time t₄. A period of no trading activity 76a begins at a time t₃ and extends back around on the timeline 62 until the time t₁. The first venue 52 reopens with all traders' accounts current and the entire process repeats starting at the time t₁.

The second venue 54 continues the trading session 70b through the time period between the times t₃ and t₅. However, at the time t₃ the settlement price for the second venue 54 is also set to the same price as set for the first venue 52. Shortly after the time t₆, accounts for traders' open positions from trades on either of the first or the second venue 52, 54 are updated based on the settlement price for the second venue 54. Trading on the second venue 54 may stop at the time t₆, as shown in FIG. 2, or trading on the second venue may be continuous for a period of days separated by periods of no trading, for example, the second venue may trade continuously from midnight on a Monday morning to midnight on a Friday night and have a period of no trading that includes Saturday and Sunday. Further, trading on the second venue 54 may be continuous seven days a week with a break once a month or once a quarter or once a year, or may be continuous without any breaks.

Regardless of whether the second venue trades for a part of each day or trades continuously for a day or several days as just described, a settlement price is periodically applied to the product traded on the second venue. For example, suppose the second venue 54 trades continuously twenty four hours a day and seven days a week, but the first venue 52 closes daily at 2 p.m. The settlement price determined from the data acquired from the first venue 52 may be applied to the second venue 54 at 2 p.m. Twelve hours later at 2 a.m., the first venue 52 has not yet re-opened however the second venue 54 may have experienced a volume of trading that has resulted in a significant shift in the product price. In such a situation, it would be useful to recompute a settlement price based on data acquired from the second venue 54 at 2 a.m. to help ensure that all parties involved in trading through the second venue are solvent and can meet their obligations to one another and to the second venue.

In fact, depending on trading patterns and price volatility, it may be useful to recompute a settlement price on a high volume venue multiple times a day. Such a settlement price may also be called a marked to market price or a margin maintenance price, and is useful for ensuring traders' solvency in markets having a single venue as well as multiple venues. The marked to market price may be computed multiple times per trading session and as frequently as necessary to ensure traders' solvency, for example, every hour or every half hour. In a venue that trades continuously 24 hours a day, seven days a week, the trading conditions may vary tremendously with time such that the marked to market price may be computed on a staggered schedule that is predetermined to match historical trading patterns. Alternatively, the marked to market price could be computed on a flexible schedule as determined by real time trading activity, or the marked to market price may be computed on demand by human intervention or by a preset trigger event.

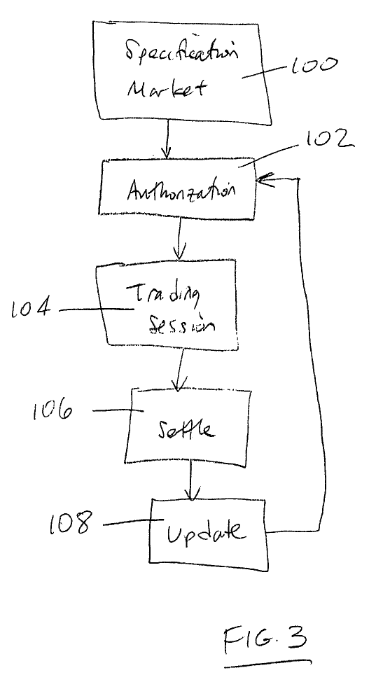

Referring next to FIG. 3, a block 100 executes tasks undertaken before a market opens on an exchange. For example, before the market for a product opens a first time, a specification for the product is established, and the market is provided for the product to be traded. Before the market opens every time including the first time, a block 102 authorizes traders to trade the product in the corresponding market provided on the exchange. Authorization of a trader depends upon a status of the trader's updated account, and authorization may be denied if a trader cannot meet his obligations. Traders may be authorized to trade a single product or may be pre-authorized to trade any product on the exchange. Still referring to FIG. 3, a block 104 accepts and notes the authorization of traders and executes orders for trading the product. The block 104 may undertake trades for a predetermined duration (as indicated by the trading session 70a in FIG. 2) or the trading session may continue through the predetermined settlement time t₃ (as indicated by the trading session 70b in FIG. 2). A block 106 determines the settlement price and a block 108 updates the traders' accounts.

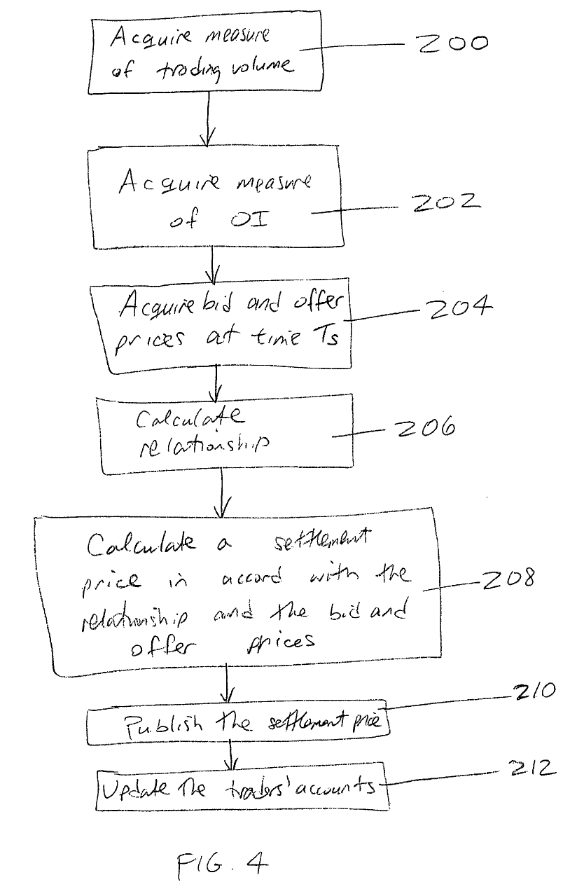

FIG. 4 shows one embodiment of a settlement procedure that is initiated, for example, at the predetermined settlement time t₃. In particular, a block 200 acquires a measure of trading volume for the product trading, for example, on the first venue 52. A block 202 acquires a measure of open interest for the product. A block 204 acquires bid and offer prices for the product at the predetermined settlement time t₃. A block 206 calculates a relationship between the measures of trading volume and open interest. A block 208 calculates a settlement price for the product in accord with the relationship and the bid and offer prices. A block 210 publishes the settlement price and a block 212 uses the settlement price to determine unrealized gains and losses of authorized traders and accordingly update their accounts on all venues providing a market for the product. In other embodiments, the measure of trading volume acquired by the block 200 and the bid and offer prices acquired by the block 204 are acquired from a second venue, for example, the second venue 54 that operates simultaneously with a first venue, for example the first venue 52.

In some embodiments, the block 200 acquires a measure of trading volume for the product having a particular contract month by summing individual volumes of all trades of the particular contract month for the product that occur on a venue of a market for the product during a configurable time period, Tₚ, that occurs just prior to a configurable settlement time, Tₛ, for example, time t₃ shown in FIG. 2. Illustratively, Tₚ is 60 seconds, but may be any other time period specified by the market. Tₛ is illustratively 2 p.m. for computing settlement prices. Tₛ may illustratively be 10 a.m., noon, and 2 p.m. for computing marked to market prices. In a market traded on a single venue, the measure of trading volume is acquired from the single venue. Alternatively, if the market is provided by the first and second venues, 52, 54, the measure of trading volume for the market may be acquired by the block 200 from the first venue or the second venue, or both of the first and second venues, wherein the second venue 54 operates simultaneously with the first venue 52 for trading the product.

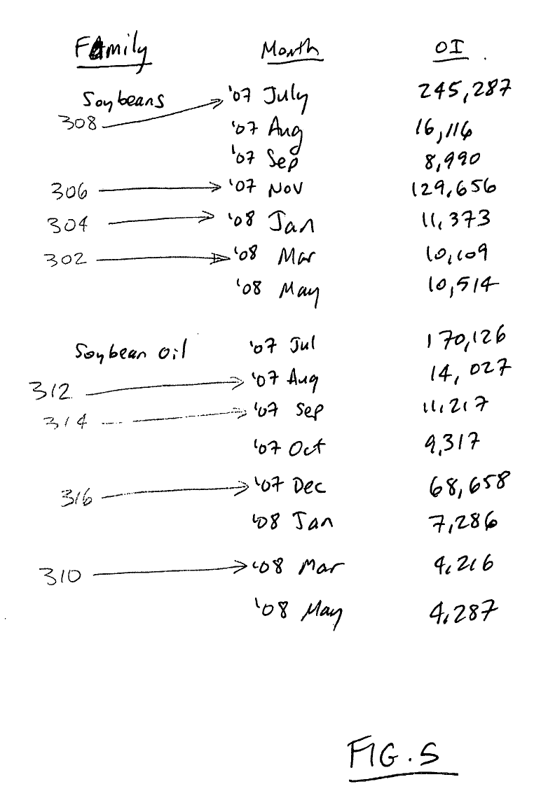

The block 202 may acquire a measure of open interest for the product by several different methods. Futures contracts, for example, may have an open interest defined for a particular contract month, or for a combination of particular contract months, or for all the contract months combined. FIG. 5 shows example open interests for all listed contract months of soybeans and soybean oil futures contracts. For example, the '08 March soybeans futures contract 302 has an open interest as indicated of 10,109 contracts. The '08 January, '07 November, and '07 July soybeans futures contracts 304, 306, and 308 each has an open interest of 11,373, 129,656, and 245,287, respectively. In addition, combinations of contract months provide a different measure of open interest. For example, the '08 January 304 and '07 November 306 contracts have a combined measure of open interest of 141,029. Further, an open interest computed for all of the contract months taken together gives yet another measure of open interest.

Further, if futures contracts for soybeans are considered to be a family of futures contracts, futures contracts for soybean oil may be considered a related family of futures contracts. The '08 March soybean oil futures contract 310 has an open interest of 4,216 contracts. The '07 August, '07 September, and '07 December soybean oil futures contracts 312, 314, and 316 each also has an open interest of 14,027, 11,217, and 68,658 contracts, respectively. Again, combinations of months provide a different measure of open interest, as may all of the contract months taken together. A combination of all the contract months of both families taken together yields yet another measure of open interest.

Referring again to FIG. 4, the block 204 acquires bid and offer prices for the product at the configurable settlement time, Tₛ. In a market having a single venue, the bid and offer prices may be acquired from the venue. Alternatively, if a market is provided by the first and second venues, 52, 54, the bid and offer prices may be acquired from the first venue or the second venue, or both the first and the second venues, wherein the second venue 54 operates simultaneously with the first venue 52 for trading the product. For example, it is contemplated that the block 204 could acquire a bid price for the product at the configurable settlement time, T, from each of the first and second venues 52, 54, and compute an average acquired bid price therefrom. Alternatively, the block 204 may acquire a bid price from each of the first and second venues 52, 54, and then select the lower value or the higher value thereof for further computations requiring the bid price. Similarly, each of the possible modes of acquiring the bid price just discussed also applies to acquisition of an offer price.

The block 206 calculates a relationship between the measure of trading volume for the product acquired by the block 200 and the measure of open interest in the product acquired by the block 202. Illustratively, the relationship may be a quotient of the measure of trading volume divided by the measure of open interest. For example, suppose the product is the '07 July soybeans futures contract 308 listed in FIG. 5. Suppose the block 200 acquires a measure of trading volume for the '07 July soybeans futures contract 308 that is, illustratively, 2,453 contracts. Also suppose the block 202 acquires a measure of open interest in the '07 July soybeans futures contract 308 that is, illustratively, 245,287 contracts. The block 206 calculates the quotient of the measure of trading volume divided by the measure of open interest in this example to be 2,453/245,287, or 1%. Suppose, for example, that the block 202 acquires a different measure of open interest for the product that is the sum of the open interest for each of the soybeans futures contracts for all of the contract months. The open interest quantities for soybeans futures contracts listed in FIG. 5 total 432,045 contracts. The block 206 calculates the quotient of the measure of trading volume divided by the measure of open interest including all contract months to be 2,453/432,045, or about 0.6%.

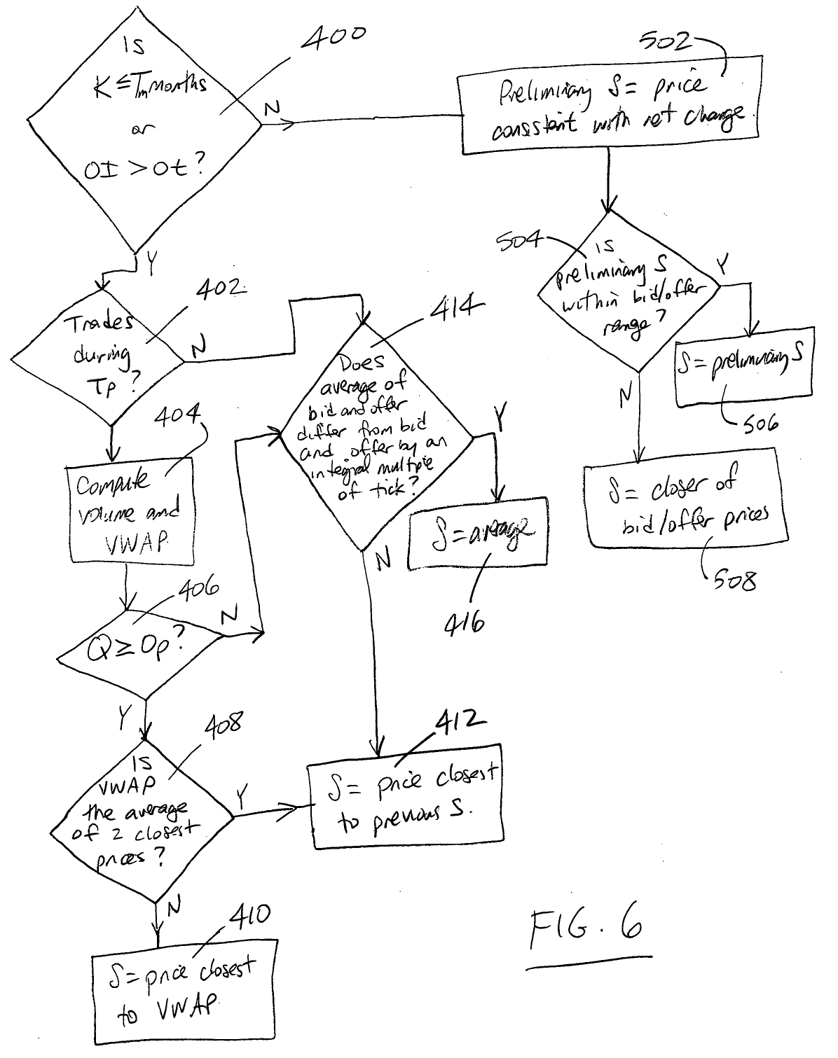

The Block 208 computes a settlement price for the product, for example a futures contract, in accord with the relationship and bid and offer prices. The steps followed to compute a settlement price for a futures contract that has a particular contract month may depend upon several factors including the contract month, a measure of open interest of the contract, and/or a quotient of a measure of trading volume divided by the measure of open interest. The block 208 compares these factors to predetermined configurable threshold parameters to select the steps included in the computation of a settlement price. FIG. 6 shows one embodiment of a detailed progression of the steps followed by the block 208.

Referring to FIG. 6, a block 400 checks whether the futures contract has a contract month that is the front month or one of the immediately following Tₘ contract months, wherein Tₘ is a predetermined configurable parameter of a number of contract months following the front month. Tₘ may range from zero to one less than the number of contracts that exist for a product, which may vary by product. For example, as seen in FIG. 5, soybeans have 7 contract months and soybean oil has 8 contract months. Therefore, Tₘ may illustratively be set to three. The front month for a futures contract is the contract month for the futures contract that is the closest to expiration. If the contract has some other contract month, the block 400 checks whether the open interest for the contract is greater than a threshold open interest parameter Oₜ. Oₜ is, a predetermined configurable parameter that may have any reasonable value for open interest, but Oₜ is illustratively set to 10,000. If block 400 yields a positive answer, processing proceeds to a block 402. Otherwise, processing proceeds to a block 502.

The block 402 determines whether the futures contract had any trading activity on the first venue 52 during the time period Tₚ. In a market traded on a single venue, the block 402 makes this determination based on the single venue. Alternatively, if a market is provided by the first and second venues, 52, 54, then the block 402 selects the venue that typically has the highest trading volume as the first venue and uses trading data acquired therefrom.

If the block 402 determines that trading activity occurred during the time period Tₚ, a block 404 computes the volume of contracts traded during the time Tₚ and a VWAP for the trading activity. A block 406 checks whether a quotient of trading volume of the futures contract during the time Tₚ divided by the measure of open interest of the futures contract is greater than or equal to a threshold quotient parameter Oₚ. The parameter Oₚ is a predetermined configurable parameter that may, for example, be set to 1%; however, Oₚ may be adjusted higher or lower to accommodate trading conditions, or for other reasons. If the block 406 yields a positive answer, then a block 408 checks whether the VWAP is the average of two closest prices in the bid and offer range at the time Tₛ. For example, suppose a product has a tick size of 0.005 and the block 404 has computed a VWAP of 94.5672. If the bid and ask prices at the time Tₛ are 94.475 and 94.670, respectively, then the two closest prices within the bid and offer range to the VWAP are 94.565 and 94.570. In this example, the block 408 determines that the VWAP is not the average of two closest prices in the bid and offer range at the time Tₛ. If the block 408 yields a negative answer, then a block 410 sets the settlement price at the one of the two closest prices within the bid and offer range at the time Tₛ that is closest to the VWAP. Continuing the previous example, the block 410 sets the settlement price to 94.565, because 94.5672 is closer to 94.565 than 94.570. If the block 408 determines that the VWAP is the average of the two closest prices in the bid and offer range at the time Tₛ, then a block 412 sets the settlement price at the one of the two closest prices within the bid and offer range at the time Tₛ that is closest to an immediately previous settlement price. Referring to the ongoing example, the block 412 sets the settlement price to whichever value of 94.565 or 94.570 that is closest to an immediately previous settlement price.

If the block 402 determines that no trading activity occurred during the time period Tₚ, or if the block 406 yields a negative answer, a block 414 checks whether an average of the bid and offer prices at the time Tₛ differs from the bid and offer prices by integer multiples of the tick. In another example, suppose bid and offer prices at the time Tₛ are 46.750 and 46.785 and a product has a tick size of 0.005. The average in this example is 46.7675, which block 414 determines does not differ from the bid and offer prices by integer multiples of the tick. The two prices that are closest to 46.7675 are 46.765 and 46.770. Therefore, in this example, the block 414 yields a negative answer, and the block 412 sets the settlement price to one of the prices 46.765 and 46.770 that is closest to an immediately previous settlement price. In a further example, suppose bid and offer prices at the time Tₛ are 46.750 and 46.780 and a product has a tick size of 0.005. The average is 46.765, which block 414 determines does differ from the bid and offer prices by integer multiples of the tick. Therefore, in this example, the block 414 yields a positive answer, and a block 416 sets the settlement price to the average of the bid and offer prices at the time Tₛ, which is 46.765.

If the block 400 determines that a futures contract has a contract month that is not the front month or one of the immediately following Tₘ months and an open interest for the contract is not greater than Oₜ, then the block 502 preliminarily sets the settlement price for the futures contract to be consistent with a net change of settlement prices for a futures contract that has an immediately preceding contract month. A block 504 compares the preliminary settlement price set in the block 502 to bid and offer prices at the time Tₛ for orders that have a predetermined minimum order size of Mₒ contracts or more. Mₒ is a predetermined configurable parameter that may, for example, be set to 100; however, Mₒ may be adjusted higher or lower to accommodate trading conditions, or for other reasons. If the block 504 determines that the preliminary settlement price is less than the bid price at the time Tₛ for an order of at least Mₒ contracts, then a block 508 sets the settlement price at the bid price at the time Tₛ. If the block 504 determines that the preliminary settlement price is more than the offer price at the time Tₛ for an order of at least Mₒ contracts, then the block 508 sets the settlement price at the offer price at the time Tₛ. If the block 504 determines that the preliminary settlement price is within a range of the bid and offer prices at the time Tₛ, a block 506 sets the settlement price at the preliminary settlement price.

Anomalous trading activity may affect the method of computing the settlement price described herein. In the event of such an occurrence or a dispute over the settlement price determined by the described method, a settlement committee may be convened to establish the settlement price independent of the described method.

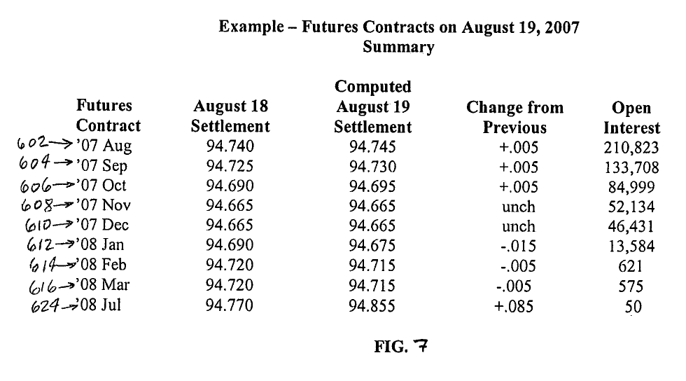

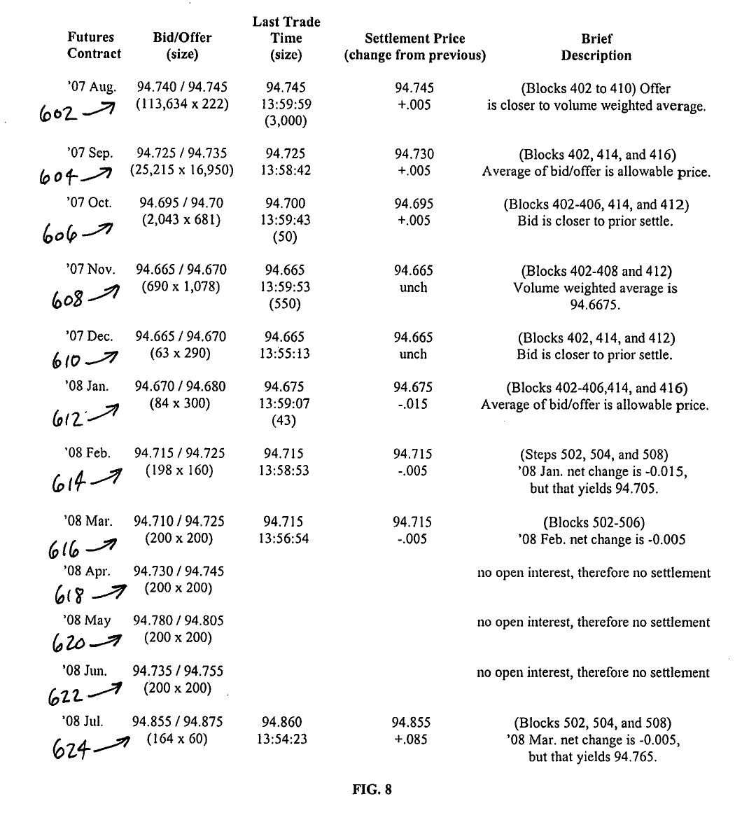

An example computation of settlement prices is presented for a family of futures contracts for Aug. 19, 2007 using fictional trading data. Results for each contract month are listed together in the summary section shown in FIG. 7. A brief description for each contract month listed in FIG. 7 is included in FIG. 8. A full description and steps from FIG. 6 that are used in each computation are provided in the explanation that follows. For the purpose of this example, '07 August is the front month, the tick size for this family of futures contracts is 0.005, and the configurable parameters are set as follows: Tₛ=2 p.m.; Tₚ=60 seconds; Oₜ=10,000; Oₚ=1%; Tₘ=3; and Mₒ=100.

Referring to FIGS. 6-8, a futures contract that has a contract month of '07 August 602 is shown to have an August 18 settlement price of 94.740. The last trade for the '07 August contract 602 was at 13:59:59, the bid/offer range at the time Tₛ was 94.740/94.745, and the open interest for this contract is 210,823. Referring to FIG. 6, the block 400 yields a positive answer because the '07 August contract 602 is the front month. The block 400 also yields a positive answer because the open interest in the '07 August contract 602 is greater than Oₜ. The block 402 yields a positive answer because the last trade for the contract occurred at 13:59:59, which is within the time period Tₚ. The block 404 acquires a measure of the volume of the '07 August contract 602 traded during the time period Tₚ, and also computes a VWAP of the trades. For illustrative purposes, assume the block 404 acquires a volume of 4,567 contracts and computes a VWAP of 94.743. The block 406 determines that the quotient of the volume of the '07 August contract 602 traded during the time Tₚ divided by the open interest of the contract is greater than Oₚ. The block 408 determines that the VWAP computed for the '07 August contract 602 is not an average of two closest prices within the bid/offer range at the time Tₛ. Therefore, the block 410 sets the settlement price for the '07 August contract 602 at 94.745, which is the one of the two closest prices within the bid and offer range at the time Tₛ that is closest to the VWAP.

A futures contract 604 that has a contract month of '07 September is shown in FIG. 7 to have an August 18 settlement price of 94.725. The last trade for the '07 September contract 604 was at 13:58:42, the bid/offer range at the time Tₛ was 94.725/94.735, and the open interest for this contract is 133,708. Referring to FIG. 6, the block 400 yields a positive answer because the '07 September contract 604 has a contract month within the first Tₘ months of the contract family beyond the front month. The block 400 also yields a positive answer because the open interest in the '07 September contract 604 is greater than Oₜ. The block 402 yields a negative answer because the last trade for the contract occurred at 13:58:42, which is not within the time period Tₚ. The block 414 determines that the average of the bid and offer prices at the time Tₛ is 94.730, which differs from the bid and offer prices by integer multiples of the tick. Therefore, the block 416 sets the settlement price of the '07 September contract 604 to the average of the bid and offer prices at the time Tₛ, which is 94.730.

A futures contract 606 that has a contract month of '07 October is shown in FIG. 7 to have an August 18 settlement price of 94.690. The last trade for the '07 October contract 606 was at 13:59:43, the bid/offer range at the time Tₛ was 94.695/94.700, and the open interest for this contract is 84,999. Referring to FIG. 6, the block 400 yields a positive answer because the '07 October contract 606 has a contract month within the first Tₘ months of the contract family beyond the front month. The block 400 also yields a positive answer because the open interest in the '07 October contract 606 is greater than Oₜ. The block 402 yields a positive answer because the last trade for the contract occurred at 13:59:43, which is within the time period Tₚ. The block 404 acquires a measure of the volume of the '07 October contract 606 traded during the time period Tₚ, and also computes a VWAP of the trades. For illustrative purposes, assume the block 404 acquires a volume of 335 contracts and computes a VWAP of 94.696. The block 406 determines that the quotient of the volume of the '07 October contract 606 traded during the time Tₚ divided by the open interest of the contract is less than Oₚ. The block 414 determines that the average of the bid and offer prices at the time Tₛ is 94.6975, which does not differ from the bid and offer prices by integer multiples of the tick. Therefore, the block 412 sets the settlement price of the '07 October contract 606 to 94.695, because 94.695 is the one of the prices 94.695 and 94.700 that is closest to an immediately previous settlement price.

A futures contract 608 that has a contract month of '07 November is shown in FIG. 7 to have an August 18 settlement price of 94.665. The last trade for the '07 November contract 608 was at 13:59:53, the bid/offer range at the time Tₛ was 94.665/94.670, and the open interest for this contract is 52,134. Referring to FIG. 6, the block 400 yields a positive answer because the '07 November contract 608 has a contract month within the first Tₘ months of the contract family beyond the front month. The block 400 also yields a positive answer because the open interest in the '07 November contract 608 is greater than Oₜ. The block 402 yields a positive answer because the last trade for the contract occurred at 13:59:53, which is within the time period Tₚ. The block 404 acquires a measure of the volume of the '07 November contract 608 traded during the time period Tₚ, and also computes a VWAP of the trades. For illustrative purposes, assume the block 404 acquires a volume of 884 contracts and computes a VWAP of 94.6675. The block 406 determines that the quotient of the volume of the '07 November contract 608 traded during the time Tₚ divided by the open interest of the contract is greater than Oₚ. The block 408 determines that the VWAP computed for the '07 November contract 608 is an average of two closest prices within the bid/offer range at the time Tₛ. Therefore, the block 412 sets the settlement price for the '07 November contract 608 at 94.665, which is the one of the two closest prices within the bid and offer range at the time Tₛ that is closest to an immediately previous settlement price.

A futures contract 610 that has a contract month of '07 December is shown in FIG. 7 to have an August 18 settlement price of 94.665. The last trade for the '07 December contract 610 was at 13:55:13, the bid/offer range at the time Tₛ was 94.665/94.670, and the open interest for this contract is 46,431. Referring to FIG. 6, the block 400 yields a positive answer because the open interest in the '07 December contract 610 is greater than Oₜ. The block 402 yields a negative answer because the last trade for the contract occurred at 13:55:13, which is not within the time period Tₚ. The block 414 determines that the average of the bid and offer prices at the time Tₛ is 94.6675, which does not differ from the bid and offer prices by integer multiples of the tick. Therefore, the block 412 sets the settlement price for the '07 December contract 610 at 94.665, which is the one of the two closest prices within the bid and offer range at the time Tₛ that is closest to an immediately previous settlement price.

A futures contract 612 that has a contract month of '08 January is shown in FIG. 7 to have an August 18 settlement price of 94.690. The last trade for the '08 January contract 612 was at 13:59:07, the bid/offer range at the time Tₛ was 94.670/94.680, and the open interest for this contract is 13,584. Referring to FIG. 6, the block 400 yields a positive answer because the open interest in the '08 January contract 612 is greater than Oₜ. The block 402 yields a positive answer because the last trade for the contract occurred at 13:59:07, which is within the time period Tₚ. The block 404 acquires a measure of the volume of the '08 January contract 612 traded during the time period Tₚ, and also computes a VWAP of the trades. For illustrative purposes, assume the block 404 acquires a volume of 68 contracts and computes a VWAP of 94.676. The block 406 determines that the quotient of the volume of the '08 January contract 612 traded during the time Tₚ divided by the open interest of the contract is less than Oₚ. The block 414 determines that the average of the bid and offer prices at the time Tₛ is 94.675, which differs from the bid and offer prices by integer multiples of the tick. Therefore, the block 416 sets the settlement price of the '08 January contract 612 to the average of the bid and offer prices at the time Tₛ, which is 94.675.

A futures contract 614 that has a contract month of '08 February is shown in FIG. 7 to have an August 18 settlement price of 94.720. The last trade for the '08 February contract 614 was at 13:58:53, the bid/offer range at the time Tₛ was 94.715/94.725, and the open interest for this contract is 621. Referring to FIG. 6, the block 400 yields a negative answer because the open interest in the '08 February contract 614 is less than Oₜ. The block 502 preliminarily sets the settlement price for the contract to 94.705, which is consistent with the net change of the '08 January contract 612. In particular, the '08 January contract 612 settled at 94.675 on August 19, which is a net change of −0.015 from the settlement price of 94.690 on August 18. Therefore, the block 502 starts with the August 18 settlement price of 94.720 for the '08 February contract 614 and subtracts 0.015 therefrom to yield 94.705. The block 504 checks whether the preliminary settlement price set by the block 502 is less than the bid price at the time Tₛ for an order of at least Mₒ contracts, or whether the preliminary settlement price is more than the offer price at the time Tₛ for an order of at least Mₒ contracts. The block 504 determines that the preliminary settlement price of 94.705 is less than the bid price of 94.715 for 198 contracts. Therefore, the block 508 sets the settlement price at the bid price, which is 94.715.

A futures contract 616 that has a contract month of '08 March is shown in FIG. 7 to have an August 18 settlement price of 94.720. The last trade for the '08 March contract 616 was at 13:56:54, the bid/offer range at the time Tₛ was 94.710/94.725, and the open interest for this contract is 575. Referring to FIG. 6, the block 400 yields a negative answer because the open interest in the '08 March contract 616 is less than Oₜ. The block 502 preliminarily sets the settlement price for the contract to 94.715, which is consistent with the net change of the '08 February contract 614. In particular, the '08 February contract 614 settled at 94.715 on August 19, which is a net change of −0.005 from the settlement price of 94.720 on August 18. Therefore, the block 502 starts with the August 18 settlement price of 94.720 for the '08 March contract 616 and subtracts 0.005 therefrom to yield 94.715. The block 504 checks whether the preliminary settlement price set by the block 502 is less than the bid price at the time Tₛ for an order of at least Mₒ contracts, or whether the preliminary settlement price is more than the offer price at the time Tₛ for an order of at least Mₒ contracts. The block 504 determines that the preliminary settlement price of 94.715 is within the bid/offer range at the time Tₛ, and therefore, the block 506 sets the settlement price for the '08 March contract 616 to the preliminary settlement price, which is 94.715.

In this example, futures contracts 618, 620, and 622 that have contract months of '08 April, '08 May, and '08 June, respectively, have no open interest and therefore computation of a settlement price is not necessary. A futures contract 624 that has a contract month of '08 July is shown in FIG. 8 to have an August 18 settlement price of 94.770. The last trade for the '08 July contract 624 was at 13:54:23, the bid/offer range at the time Tₛ was 94.855/94.875, and the open interest for this contract is 50. Referring to FIG. 6, the block 400 yields a negative answer because the open interest in the '08 July contract 624 is less than Oₜ. The block 502 preliminarily sets the settlement price for the contract to 94.765, which is the price that is consistent with the net change of the '08 March contract 616. In particular, the '08 March contract 616 settled at 94.715 on August 19, which is a net change of −0.005 from the settlement price of 94.720 on August 18. Therefore, the block 502 starts with the August 18 settlement price of 94.770 for the '08 July contract 624 and subtracts 0.005 therefrom to yield 94.765. The block 504 checks whether the preliminary settlement price set by the block 502 is less than the bid price at the time Tₛ for an order of at least M₀ contracts, or whether the preliminary settlement price is more than the offer price at the time Tₛ for an order of at least M₀ contracts. The block 504 determines that the preliminary settlement price of 94.765 is less than the bid price of 94.855 for 164 contracts. Therefore, the block 508 sets the settlement price at the bid price, which is 94.855.

### INDUSTRIAL APPLICABILITY

Settlement prices for products traded on a venue of an exchange are used to update traders' accounts, which assures that all parties involved in trading through the exchange are solvent and can meet their obligations. Settlement prices are typically computed in a variety of ways depending upon trading conditions, and under some conditions disputes can arise as to a computed price or a particular method used to calculate the price. This invention establishes a system for computing settlement prices that is responsive to trading conditions without being arbitrary.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A computer assisted method of operating a venue of an exchange, comprising the steps of:
providing a market for trading of a product;
acquiring a measure of trading volume of the product;
developing a measure of open interest in the product;
calculating a relationship between the measure of trading volume and the measure of open interest; and
computing a settlement price in accordance with the relationship; and
publishing the settlement price.

2. The computer assisted method of claim 1, wherein the step of calculating the relationship comprises the step of calculating a quotient of the measure of trading volume divided by the measure of open interest.

3. The computer assisted method of claim 1, wherein the step of acquiring a measure of trading volume comprises the step of acquiring a measure of trading volume of the product from a second venue.

4. The computer assisted method of claim 1, wherein the product has a contract month associated therewith and the step of developing a measure of open interest in the product comprises calculating an open interest for each of a plurality of related products.

5. The computer assisted method of claim 1, wherein the method further comprises the step of acquiring bid and offer prices for the product, and wherein the step of computing the settlement price comprises the step of computing the settlement price in accordance with the relationship and the bid and offer prices for the product.

6. The computer assisted method of claim 5, wherein the step of acquiring the bid and offer prices for the product comprises the step of acquiring the bid and offer prices for the product from a second venue.

7. The computer assisted method of claim 1, wherein the method further comprises the step of authorizing traders to trade the product.

8. The computer assisted method of claim 7, wherein the method further comprises the step of determining gains and losses of authorized traders based upon the settlement price.

9. A method of using a computer to determine a settlement price for a product traded on a venue of an exchange, comprising the steps of:
acquiring a measure of trading volume of the product;
developing a measure of open interest in the product;
calculating a relationship between the measure of trading volume and the measure of open interest; and
computing the settlement price in accordance with the relationship.

10. The method of claim 9, wherein the step of calculating the relationship comprises the step of calculating a quotient of the measure of trading volume divided by the measure of open interest.

11. The method of claim 9, wherein the step of acquiring a measure of trading volume comprises the step of acquiring a measure of trading volume of the product from a second venue.

12. The method of claim 9, wherein the product has a contract month associated therewith and the step of developing a measure of open interest in the product comprises calculating an open interest for each of a plurality of related products.

13. The method of claim 9, wherein the method further comprises the step of acquiring bid and offer prices for the product, and wherein the step of computing the settlement price comprises the step of computing the settlement price in accordance with the relationship and the bid and offer prices for the product.

14. The method of claim 13, wherein the step of acquiring the bid and offer prices for the product comprises the step of acquiring the bid and offer prices for the product from a second venue.

15. A method of using a computer to determine a settlement price for a product traded on a first venue, comprising the steps of:
acquiring a measure of trading volume of the product from a second venue;
developing a measure of open interest in the product;
collecting bid and offer prices for the product;
calculating a relationship between the measure of trading volume and the measure of open interest; and
computing the settlement price in accordance with the relationship and the bid and offer prices.

16. The method of claim 15, wherein the step of calculating the relationship comprises the step of calculating a quotient of the measure of trading volume divided by the measure of open interest.

17. The method of claim 15, wherein the product has a contract month associated therewith and the step of developing a measure of open interest in the product comprises calculating an open interest for each of a plurality of related products.

18. The method of claim 15, wherein the step of acquiring the bid and offer prices for the product comprises the step of acquiring the bid and offer prices for the product from a second venue.

19. A system for operating a venue that provides a market for trading a product, wherein the system comprises:
a computer-readable medium; and
a software program stored in the computer-readable medium and comprising
a first routine that acquires a measure of trading volume of the product;
a second routine that develops a measure of open interest in the product;
a third routine that calculates a relationship between the measure of trading volume and the measure of open interest;
a fourth routine that computes a settlement price in accordance with the relationship; and
a fifth routine that publishes the settlement price.

20. The system of claim 19, wherein the third routine calculates a quotient of the measure of trading volume divided by the measure of open interest.

21. The system of claim 19, wherein the first routine acquires a measure of trading volume of the product from a second venue.

22. The system of claim 19, wherein the product has a contract month associated therewith and the second routine calculates an open interest for each of a plurality of related products.

23. The system of claim 19, wherein the software program further comprises a sixth routine that acquires bid and offer prices for the product, and wherein the fourth routine computes the settlement price in accordance with the relationship and the bid and offer prices for the product.

24. The system of claim 23, wherein the sixth routine acquires the bid and offer prices for the product from a second venue.

25. The system of claim 19, wherein the software program further comprises a seventh routine that authorizes traders to trade the product.

26. The system of claim 25, wherein the software program further comprises an eighth routine that determines gains and losses of authorized traders based upon the settling price.

27. A method of using a computer to periodically update a trader's account, comprising the steps of:
determining a marked to market price a plurality of times during a trading session for a product traded on an exchange;
calculating a net change of the trader's account based upon the determined marked to market price; and
updating the trader's account based upon the calculated gains and losses.

28. The method of claim 27, wherein the step of determining a marked to market price a plurality of times during a trading session for a product traded on an exchange comprises the step of determining the marked to market price based upon a predetermined schedule during each trading session.

29. The method of claim 27, wherein the step of determining a marked to market price a plurality of times during a trading session for a product traded on an exchange comprises the step of determining the marked to market price based upon a flexible schedule during each trading session, wherein the flexible schedule is responsive to trading activity of the product.

30. The method of claim 29, wherein trading activity of the product includes at least one or more of trading volume, price volatility, open interest, and difference between bid and ask prices.

31. The method of claim 27, wherein the step of determining a marked to market price a plurality of times during a trading session for a product traded on an exchange comprises the step of determining the marked to market price on demand at any time during the trading session.
